(19) United States
(12) Patent Application Publication
(10) Pub. No.: US 2006/0256201 A1
(43) Pub. Date: Nov. 16, 2006

(54) Methods and systems for controlling camera movement

(75) Inventor: Peter Shuttleworth, Philomath, OR (US)

Correspondence Address: PATRICK W. RASCHE (22697);ARMSTRONG TEASDALE LLP, ONE METROPOLITAN SQUARE, SUITE 2600, ST. LOUIS, MO, 63102-2740, US

(73) Assignee: GE Security, Inc.

(21) Appl. No.: 11/125,880

(22) Filed: May 10, 2005

(51) Int. Cl. H04N 5/232

(52) U.S. Cl. 348/211.9

(57) ABSTRACT

Methods and systems for controlling movements of cameras include a video camera having a field of view wherein the camera is configured to tilt about a tilt axis, and at least one processor operably coupled to the camera wherein the processor is configured to receive at least one of a pan and a tilt position indication and a current zoom setting to determine a camera movement travel limit.

### BACKGROUND OF THE INVENTION

This invention relates generally to video surveillance systems and, more particularly, to controlling movements of camera pan, tilt, and zoom assemblies.

At least some known video surveillance systems include one or more video cameras mounted in a housing along with a pan, tilt, and zoom (PTZ) assembly. The PTZ permits controlling a movement of the camera to align a viewing area of the camera with an object of interest or location of interest. The zoom portion of the mechanism may be used to adjust a field of view of the camera. The housing typically includes an enclosure and a transparent or semi transparent hemispheric dome. The housing protects the camera from the environment in the location where the camera and PTZ assembly are mounted.

In some instances, the camera may be tilted to an angle where a portion of the enclosure undesirably enters the viewing area of the camera. A tilt travel limit may be set such that further tilting of the camera is prevented prior to the enclosure entering the viewing area. However, such a limit may be unnecessarily restrictive at certain zoom settings. For example, a tilt travel limit set when the camera is zoomed out, i.e. relatively wide field of view, is unnecessarily restrictive when the camera is zoomed in, i.e. relatively narrow field of view. When the camera is zoomed-in, it can tilt more before the enclosure enters the viewing area.

### BRIEF DESCRIPTION OF THE INVENTION

In one embodiment, a system for controlling movements of cameras includes a video camera having a field of view wherein the camera is configured to tilt about a tilt axis, and at least one processor operably coupled to the camera wherein the processor is configured to receive at least one of a pan and a tilt position indication and a current zoom setting to determine a camera movement travel limit.

In another embodiment, a computer program embodied on a computer readable medium for controlling the operation of at least one camera includes at least one code segment that instructs the processor to receive at least one of a pan and a tilt position indication for the camera, receive a current zoom setting for the camera, and determine a camera movement travel limit using the at least one of a pan and a tilt position indication and the current zoom setting.

In yet another embodiment, a method of controlling the movement of a video camera includes providing a video camera having a variable field of view and a movement travel limit, and controlling the movement travel limit using a setting of the field of view.

### BRIEF DESCRIPTION OF THE DRAWINGS

FIG. 1 is a schematic view of an exemplary video surveillance system in accordance with an embodiment of the present invention;

FIG. 2 is a schematic block diagram of an exemplary embodiment of the camera shown in FIG. 1;

FIG. 3 is an enlarged perspective view of an exemplary embodiment of PTZ assembly shown in FIG. 1; and

FIG. 4 is a flowchart of an exemplary method of controlling the movement of a video camera such as camera shown in FIG. 1.

### DETAILED DESCRIPTION OF THE INVENTION

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

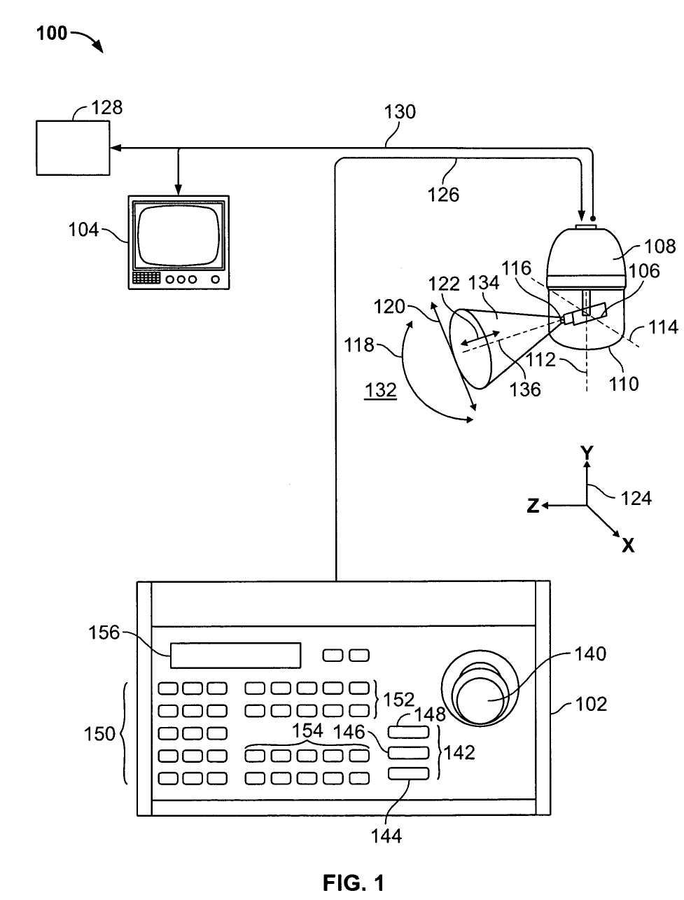

FIG. 1 is a schematic view of an exemplary video surveillance system 100 in accordance with an embodiment of the present invention. Video surveillance system 100 includes a control panel 102, a display monitor 104, and a pan, tilt, and zoom (PTZ) video camera 106. Typically, camera 106 is housed in an enclosure 108 having a dome 110 for protecting camera 106 from the environment where camera 106 is located. In one embodiment, dome 110 is tinted to allow camera 106 to acquire images of the environment outside of enclosure 108 and simultaneously prevent individuals in the environment being observed by camera 106 from determining the orientation of camera 106. In various alternative embodiments, dome 110 is not tinted. In the exemplary embodiment, camera 106 includes capabilities to pan about a vertical axis 112, tilt about a horizontal axis 114, and control a lens assembly 116 to cause camera 106 to zoom. For example, PTZ assembly 100 includes a pan motor and encoder 113 and tilt motor and encoder 115. The encoders determine an angular position of the pan and tilt motor and generate position signals that are used with a zoom setting to determine an area in the field of view. Panning movement of camera 106 is represented by an arrow 118, tilting movement of camera 106 is represented by arrow 120 and the changing of the focal length of lens assembly 116 of camera 106, i.e., zooming, is represented by arrow 122. As shown with reference to a coordinate system 124, panning motion may track movement along the x-axis, titling motion may track movement along the y-axis and focal length adjustment may be used to track movement along the z-axis. Signals representing commands to control such capabilities are transmitted from control panel 102 through a control data line 126. Image data signals are transmitted from camera 106 to display monitor 104 and a storage device 128 through a video data line 130.

Lens assembly 116 views an area of a location 132, which may be remote from control panel 102 and is in a field of view 134 and along a viewing axis 136 of lens assembly 116. Images of location 132 are converted by camera 106 into an electrical video signal, which is transmitted to display monitor 104.

In the exemplary embodiment, control panel 102 includes an X-Y control joystick 140 that is used to generate pan and tilt commands. A plurality of rocker-type switches 142 are used to control a zoom 144, a focus 146, and an iris 148 of lens assembly 116. In an alternative embodiment, joystick 140 includes a twist actuation that is used to control the zoom of camera 106. Joystick 140 may also incorporate triggers and/or buttons to facilitate operating various controls associated with system 100. Control panel 102 also includes a numeric keypad 150 for entering numbers and values. In an alternative embodiment, control panel 102 may include an alpha or alphanumeric keypad (not shown) for entering text as well as numbers. Control panel 102 further includes a plurality of preset switches 152 that may be programmed to execute macros that automatically control the actions of camera 106 and/or lens assembly 116. A plurality of buttons 154 may be used, for example, for predetermined control functions and/or user-defined functions, for example, a camera selection in a multi-camera video surveillance system. A display 156 may be used to display a status of video surveillance system 100 or may be used to display parameters associated with a selected camera.

In the exemplary embodiment, video surveillance system 100 is a single camera application, however, various embodiments of the present invention may be used within a larger surveillance system having additional cameras which may be either stationary or moveable cameras or some combination thereof to provide coverage of a larger or more complex surveillance area. In an alternative embodiment, one or more video recorders (not shown) are connected to control panel 32 to provide for recording of video images captured by camera 13 and other cameras in system 100.

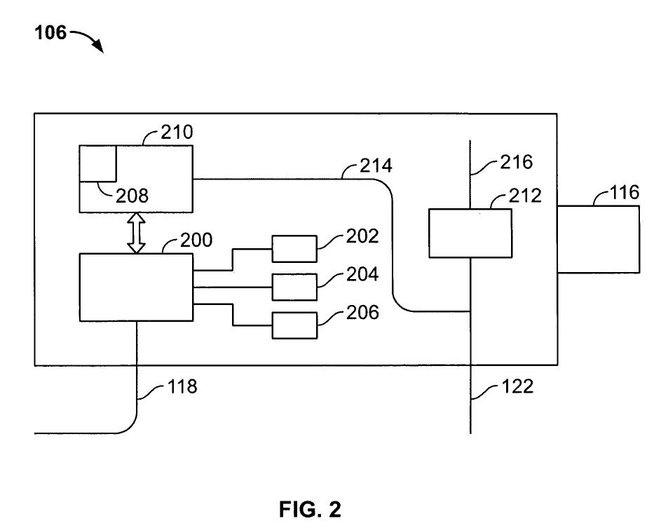

FIG. 2 is a schematic block diagram of an exemplary embodiment of camera 106 (shown in FIG. 1). In the exemplary embodiment, camera 106 includes a decoder module 200 that receives commands from control panel 102 through control data line 126. Decoder module 200 decodes the commands and transmits the decoded commands to various modules within camera 106. For example, a command may be a movement command that includes commands such as a pan command, a tilt command, and a zoom command. The pan command may be transmitted to a pan motor 202, the tilt command may be transmitted to a tilt motor 204, and the zoom command may be transmitted to a zoom actuator 206. Other commands, such as a preset command and a configuration command may be decoded to provide commands to initiate actions to be carried out by camera 106. For example, a preset command may be decoded to initiate execution of a macro stored in a memory 208 of a processor 210. The macro may include a series of commands to be executed in a sequence to carry out a predetermined series of camera movements and operations.

An image assembly 212 may convert light received through lens assembly 116 into electrical signals representative of an image of location 132. The electrical signals may be transmitted to monitor 104 or storage device 128 through video data line 130. In the exemplary embodiment, a line 214 may be used to transmit other video signals to monitor 104. For example, processor 210 may be programmed to generate a menu of user selectable options for display on monitor 104. When the menu is active, video signals from image assembly may be prevented from being transmitted through video data line 130, for example, by removing a signal from a video output enable input 216 of image assembly 212. Alternatively, when the menu is active, the video signals from image assembly 212 may be formatted such that the image represented by the video signals covers only a portion of a screen area of monitor 104.

Processor 210 receives programmed instructions, from software or firmware, and data from memory 208 and performs various operations using the data and instructions. Processor 210 may include an arithmetic logic unit (ALU) that performs arithmetic and logical operations and a control unit that extracts instructions from memory 208 and decodes and executes them, calling on the ALU when necessary. Memory 208 generally includes a random-access memory (RAM) and a read-only memory (ROM), however, there may be other types of memory such as programmable read-only memory (PROM), erasable programmable read-only memory (EPROM) and electrically erasable programmable read-only memory (EEPROM). In addition, memory 208 may include an operating system, which executes on processor 210. The operating system performs basic tasks that include recognizing input, sending output to output devices, keeping track of files and directories and controlling various peripheral devices.

The term processor, as used herein, refers to central processing units, microprocessors, microcontrollers, reduced instruction set circuits (RISC), application specific integrated circuits (ASIC), logic circuits, and any other circuit or processor capable of executing the functions described herein. Memory 208 may include storage locations for the preset macro instructions that may be accessible using one of the plurality of preset switches 142.

As used herein, the terms “software” and “firmware” are interchangeable, and include any computer program stored in memory for execution by processor 210, including RAM memory, ROM memory, EPROM memory, EEPROM memory, and non-volatile RAM (NVRAM) memory. The above memory types are exemplary only, and are thus not limiting as to the types of memory usable for storage of a computer program.

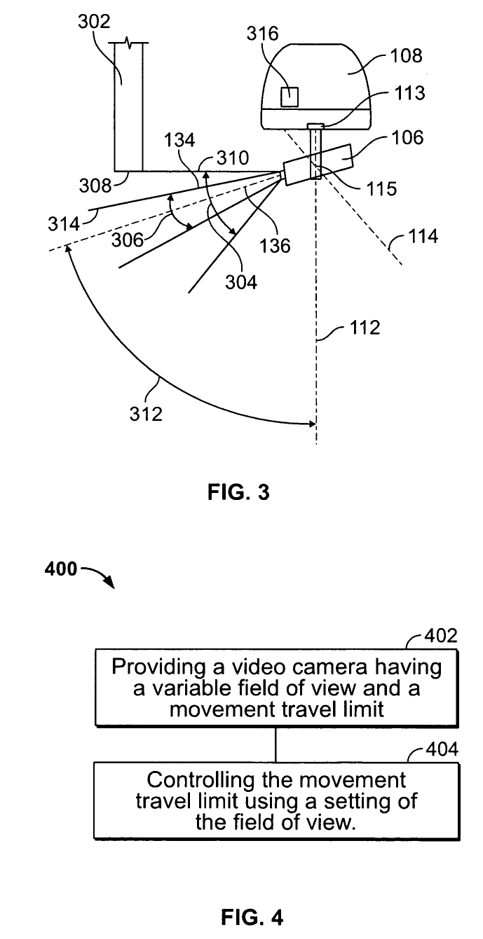

FIG. 3 is an enlarged perspective view of an exemplary embodiment of PTZ assembly 100 (shown in FIG. 1). Due to the geometry of enclosure 108 and the varying field of view of the camera at different levels of zoom a compromise is made between the maximum tilt motion (rotation about tilt axis 114) and the amount of enclosure 108 that is acceptable in the image. For example, camera 106 could have an unobstructed (by the enclosure) view when at high zoom but is prevented from tilting up farther than the limit set at wide angle (low zoom). To permit full range of motion of camera 106 while maintaining enclosures 108 and other obstacles outside the viewing area, knowledge of the system geometry and current zoom position are used to actively vary the tilt travel limit(s). Obstacles may be structures, walls, equipment, sources of bright light that may blind camera 106, or other members, which may interfere with or distract a user. This will facilitate ensuring that camera 106 is able to travel as far as possible without having enclosure 108 substantially obscure the field of view of camera 106. In addition to limiting obstacles from obscuring the field of view, dynamically varying the camera movement limits permits observing privacy rights of nearby facilities. For example, many locations using surveillance are located proximate apartment buildings and homes. Dynamic travel limits permit excluding apartment windows from the field of view of camera 106 when camera 106 is pointed in the direction of dwellings. FIG. 3 illustrates an obstacle 302 located proximate PTZ assembly 100 that, during at least some operations of PTZ assembly 100, will be in the field of view of camera 106. To prevent obstacle from being in the field of view of camera 106 during operation, a travel limit may be placed on the tilt and/or pan controls of PTZ assembly 100. However, because camera 106 has a zoom capability, a fixed travel limit will either limit the field of view of camera 106 unnecessarily when camera 106 is zoomed in, i.e., the field of view is relatively narrow, or will permit obstacle 302 to enter the field of view of camera 106 in cases where camera 106 is zoomed out, i.e., the field of view is relatively wide. In the exemplary embodiment, PTZ assembly 100 includes a dynamically variable pan and/or tilt travel limit that is determined based on the movement commands received by camera 106 and known geometry of the environment of camera 106. In the exemplary embodiment, obstacle 302 is illustrated as an object separate from PTZ assembly 100. In various embodiments, obstacle 302 is a portion of enclosure 108.

At a first zoom setting, camera 106 has a field of view defined by an angle 304. At a second zoom setting, camera 106 has a field of view defined by an angle 306. With camera 106 set for a field of view angle 304, a lower end 308 of obstacle 302 is coincident with an edge 310 of field of view 304 at a tilt angle 312. If camera 106 is zoomed in to the second zoom setting the angle of the field of view changes from angle 304 to angle 306. An edge 314 of the field of view at the second zoom setting is not coincident with lower end 308, but rather there is an angular difference between lower end 308 and edge 314. Camera 106 could be tilted by an angle approximately equal to angle 312 plus one-half the angular difference between angle 304 and angle 306 before lower end 308 enters the field of view of camera 106 at the second zoom setting. In the exemplary embodiment, an automatic field of view compensation module 316 determines a geometry of the field of view for each zoom setting and dynamically adjusts the tilt travel limit to ensure that obstacle 302 does not enter the field of view of camera 106 during all operations of PTZ assembly 100.

At the second zoom setting, tilt angle 312 may be increased until lower end 308 is coincident with edge 314. At this point obstacle 302 is not in the field of view of camera 106. If, without adjusting tilt angle 312, camera 106 was zoomed out to angle 304, lower end 308 would enter the field of view of camera 106. To prevent lower end 308 from entering the field of view, automatic field of view compensation module 316 generates a tilt command to tilt camera 106 away from lower end 308 such that the field of view is changed from angle 306 to angle 304 without lower end 308 entering the field of view.

Although automatic field of view compensation module 316 is illustrated as generating a tilt command for an obstacle oriented above camera 106, automatic field of view compensation module 316 also limits the tilt travel and/or generates tilt commands when an obstacle is oriented below camera 106 such as proximate axis 112. Further, automatic field of view compensation module 316 also limits the pan travel and/or generates pan commands such that obstacles are prevented from entering the field of view of camera 106 during panning operations.

In an alternative embodiment, automatic field of view compensation module 316 permits a portion of an obstacle into the field of view to aid the user in understanding why the travel of camera 106 is limited. Without such a visual cue, the user may believe the system is malfunctioning and initiate maintenance measures unnecessarily.

FIG. 4 is a flowchart of an exemplary method 400 of controlling the movement of a video camera such as camera 106 (shown in FIG. 1). In the exemplary embodiment, a camera is provided 402 such as camera 106, which is a video type camera that has a variable field of view or zoom function. Camera 106 includes a capability to pan about a substantially vertical pan axis and tilt about a tilt axis that is orthogonal to the pan axis using PTZ assembly 100. To avoid impacting structure near camera 106 a movement travel limit is incorporated into the controls for PTZ assembly 100. The movement travel limit is also used to prevent structure and obstacles from appearing in the viewing area of camera 106. Method 400 includes controlling 404 the movement travel limit using a setting of the field of view. In the exemplary embodiment, a processor is configured to receive an angular position signal from an encoder coupled to the tilt and/or pan motor to determine a direction that camera 106 is pointing. In an alternative embodiment, system 100 operate in open loop control such that an input from a position encoder is not used, but rather, the movement controls for camera 106 are assumed to reach the positions to which they are commanded. The processor also receives a signal indicative of the field of view or zoom setting of camera 106 to facilitate determining the viewing area of camera 106. Coordinates of obstacles and/or structure in potential viewing areas of camera 106 are stored in a memory associated with the processor. The position signals and zoom setting are compared to the coordinates of the obstacles and structures to determine whether the obstacles or structures will be in the viewing area of camera 106. The processor generates movement travel limits to prevent camera from panning or tilting to such an angle that the obstacle or structure enters the viewing area of camera 106. The processor also generates movement commands to move camera 106 away from obstacles or structure to prevent the obstacles or structures from entering the viewing area due to a change in the zoom setting. References to a current zoom setting, a pan position indication, and a tilt position indication include information derived from signals from position sensors, and from position assumptions made for open loop control systems.

Although the embodiments described herein are discussed with respect to a video surveillance system, it is understood that the automatic field of view compensation described herein may be used with other mechanical and electro-mechanical systems.

It will be appreciated that the use of first and second or other similar nomenclature for denoting similar items is not intended to specify or imply any particular order unless otherwise stated.

The above-described embodiments of a video surveillance system provide a cost-effective and reliable means for facilitating a user perception of performance by reducing obstacles and/or structures that may otherwise be introduced into the viewing area of the camera.

Exemplary embodiments of video surveillance systems and apparatus are described above in detail. The video surveillance system components illustrated are not limited to the specific embodiments described herein, but rather, components of each system may be utilized independently and separately from other components described herein. For example, the video surveillance system components described above may also be used in combination with different video surveillance system components. A technical effect of the various embodiments of the systems and methods described herein include facilitating operation of the video surveillance system by using the field of view of the camera to modify movement travel limits for the camera to prevent obstacles from appearing to block the viewing area of the camera without imposing arbitrary motion limits that restrict the potential coverage of the camera system.

While the invention has been described in terms of various specific embodiments, those skilled in the art will recognize that the invention can be practiced with modification within the spirit and scope of the claims.

What is claimed is:

1. A system for controlling movements of cameras comprising:
a video camera comprising a field of view, said camera configured to at least one of zoom to change the camera field of view, tilt about a tilt axis, and pan about a pan axis; and
at least one processor operably coupled to said camera wherein said processor is configured to determine a camera movement travel limit using at least one of a current zoom setting, a pan position indication, and a tilt position indication.

2. A system in accordance with claim 1 further comprising a sensor configured to determine at least one of a current zoom setting, a pan position indication, and a tilt position indication.

3. A system in accordance with claim 1 wherein said processor is configured to receive a set of coordinates associated with at least one obstacle, the set of coordinates corresponding to the at least one of a current zoom setting, a pan position indication, and a tilt position indication.

4. A system in accordance with claim 3 wherein said processor is programmed to determine a camera movement travel limit using the at least one of a current zoom setting, a pan position indication, and a tilt position indication to avoid viewing a predetermined obstacle in the field of view.

5. A system in accordance with claim 4 wherein said processor is programmed to compare the set of coordinates to the at least one of a current zoom setting, a pan position indication, and a tilt position indication to determine a movement travel limit that substantially prevents positioning said camera such that an obstacle is in the field of view.

6. A system in accordance with claim 3 wherein said processor is programmed to determine a camera movement command using the at least one of a current zoom setting, a pan position indication, and a tilt position indication.

7. A system in accordance with claim 6 wherein said processor is programmed to compare the set of coordinates to the at least one of a current zoom setting, a pan position indication, and a tilt position indication to determine a movement command that at least one of pans and tilts said camera to maintain an obstacle outside the field of view.

8. A system in accordance with claim 1 wherein the predetermined obstacle is an enclosure at least partially surrounding said camera, said processor programmed to determine a camera tilt angle limit using a geometry of said enclosure, the tilt position indication and the zoom setting.

9. A system in accordance with claim 8 wherein said processor is programmed to:
determine a first camera tilt angle limit for a zoom setting defined by a first field of view angle;
prevent said camera from exceeding the first camera tilt angle limit;
determine a second camera tilt angle limit for a zoom setting defined by a second field of view angle; and
permit said camera to exceed the first camera tilt angle limit and prevent said camera from exceeding the second camera tilt angle limit.

10. A computer program embodied on a computer readable medium for controlling the operation of at least one camera, said program comprising at least one code segment that instructs a processor to determine a camera movement travel limit using at least one of a pan and a tilt position indication and the current zoom setting.

11. A computer program in accordance with claim 10 further comprising at least one code segment that receives a set of coordinates associated with at least one obstacle, the set of coordinates corresponding to the at least one of a pan position indication and tilt position indication and the zoom setting.

12. A computer program in accordance with claim 11 further comprising at least one code segment that determines a camera movement travel limit using the at least one of a pan position indication and a tilt position indication and a current zoom setting to avoid viewing a predetermined obstacle in the field of view.

13. A computer program in accordance with claim 12 further comprising at least one code segment that compares the set of coordinates to the at least one of a pan position indication and a tilt position indication and the current zoom setting to determine a movement travel limit that substantially prevents a movement of said camera that permits an obstacle into the field of view.

14. A computer program in accordance with claim 11 further comprising at least one code segment that determines a camera movement command using the at least one of a pan position indication and a tilt position indication and the current zoom setting.

15. A computer program in accordance with claim 14 further comprising at least one code segment that compares the set of coordinates to the at least one of a pan position indication and a tilt position indication and the current zoom setting to determine a movement command that at least one of pans and tilts said camera to maintain an obstacle outside the field of view.

16. A computer program in accordance with claim 10 wherein the predetermined obstacle is an enclosure at least partially surrounding said camera, said computer program further comprising at least one code segment that determines a camera tilt angle limit using the geometry of said enclosure, tilt position indication and the zoom setting.

17. A computer program in accordance with claim 16 further comprising at least one code segment that:
determines a first camera tilt angle limit for a zoom setting defined by a first field of view angle;
prevents said camera from exceeding the first camera tilt angle limit;
determines a second camera tilt angle limit for a zoom setting defined by a second field of view angle
permits said camera to exceed the first camera tilt angle limit and prevent said camera from exceeding the second camera tilt angle limit.

18. A method of controlling the movement of a video camera, said method comprising:
providing a video camera having a variable field of view and a movement travel limit; and
controlling the movement travel limit using a setting of the field of view.

19. A method in accordance with claim 18 wherein controlling the movement travel limit using the field of view comprises adjusting the movement travel limit of the camera using the field of view setting to avoid viewing an obstacle in the field of view.

20. A method in accordance with claim 18 wherein controlling the movement travel limit using the field of view comprises identifying obstacles to avoid viewing in the field of view.

21. A method in accordance with claim 18 wherein controlling the movement travel limit using the field of view comprises:
receiving at least one of a pan angular position indication and a tilt angular position indication from a respective position encoder; and
receiving a current field of view setting.

22. A method in accordance with claim 21 wherein controlling the movement travel limit using the field of view comprises comparing the at least one of a pan angular position indication and a tilt angular position indication and the current field of view setting to one or more predetermined obstacle coordinates.

23. A method in accordance with claim 22 further comprising:
permitting at least one of a pan operation or a tilt operation if an obstacle is not in the field of view.
stopping the at least one of a pan operation and a tilt operation if the obstacle is on the edge of the field of view; and
generating a movement command if the obstacle in within the field of view.

24. A method in accordance with claim 21 wherein controlling the movement travel limit using the field of view comprises comparing the at least one of a pan and a tilt angular position indication and the current field of view setting to one or more predetermined obstacle coordinates.

25. A method in accordance with claim 24 further comprising:
modifying the movement travel limit to permit the at least one of a pan operation and tilt operation toward the obstacle during a zoom in operation; and
generating a movement command to maintain the obstacle outside the field of view during a zoom out operation.
